(19) United States
(12) Patent Application Publication
(10) Pub. No.: US 2005/0158084 A1
(43) Pub. Date: Jul. 21, 2005

(54) Developing device and electrophotographic image forming apparatus having the same

(76) Inventor: Soon-nam Kim, Suwon-si (KR)

Correspondence Address: STANZIONE & KIM, LLP, 1740 N STREET, N.W., FIRST FLOOR, WASHINGTON, DC, 20036, US

(21) Appl. No.: 11/020,139

(22) Filed: Dec. 27, 2004

(30) Foreign Application Priority Data
Jan. 19, 2004 (KR) 2004-3807

(51) Int. Cl. G03G 15/08

(52) U.S. Cl. 399/286

(57) ABSTRACT

A developing device having a conductive elastomer of a developing agent transferring body which develops an image in a contact or noncontact manner, and an electrophotographic image forming apparatus having the same. The developing device develops a nonmagnetic one component developing agent in a contact development manner on a photosensitive medium on which an electrostatic latent image is formed by an incident scanned beam. The developing device includes a housing in which the developing agent is stored, and a developing agent transferring body which includes a shaft installed to be rotated inside the housing and a conductive elastomer surrounding an outer circumference of the shaft and contacting the photosensitive medium to transfer the developing agent stored in the housing to the photosensitive medium, wherein a thickness of the conductive elastomer is less than 2 mm.

### CROSS-REFERENCE TO RELATED APPLICATIONS

This application claims the priority of Korean Patent Application No. 2004-3807, filed on Jan. 19, 2004, in the Korean Intellectual Property Office, the disclosure of which is incorporated herein in its entirety by reference.

### BACKGROUND OF THE INVENTION

1. Field of the Invention

The present general inventive concept relates to a developing device which develops an image in a contact manner, and an electrophotographic image forming apparatus having the same, and more particularly, to a developing device having an improved conductive elastomer of a developing agent transferring body, and an electrophotographic image forming apparatus having the same.

2. Description of the Related Art

In general, an electrophotographic image forming apparatus, such as a laser printer, a facsimile, or a digital copier, is an apparatus which forms an electrostatic latent image by radiating light onto a photosensitive medium charged to a predetermined potential, develops the electrostatic latent image with a predetermined color of toner, transfers the developed image onto a sheet of paper, and fuses the transferred image on the sheet of paper, thereby printing an image.

Referring to FIGS. 1 through 3, a conventional electrophotographic image forming apparatus includes a cabinet 10, a charger 11 provided inside the cabinet 10, a photosensitive drum 13, a laser scanning unit (LSU) 15, a developing device 20, a transfer roller 17, and a fusing roller 19.

The photosensitive drum 13 is charged by the charger 11 to a predetermined potential and forms an electrostatic latent image corresponding to an image to be printed in response to a laser beam L irradiated by the LSU 15.

The developing device 20 stores a developing agent T in a container 27, supplies the developing agent T to the photosensitive drum 13 on which the electrostatic latent image is formed, using a supplying roller 25 and a developing roller 21. In this case, a regulating blade 26 is provided at an outer circumference of the developing roller 21 to regulate an amount of the developing agent T.

As described above, the image formed on the photosensitive drum 13 is transferred onto a sheet of paper S fed between the photosensitive drum 13 and the transfer roller 17 and is fused on the sheet of paper S using the fusing roller 19.

The developing roller 21 includes a shaft 22 installed to be rotated on a frame, and a conductive elastomer 23 which is provided at an outer circumference of the shaft 22. A DC voltage is applied from a power supply unit to the developing roller 21 so that the developing agent T supplied by electrophotography can be transferred to the electrostatic latent image formed on the photosensitive drum 13.

The shaft 22 is formed of a stainless steel material, and the conductive elastomer 23 provided at the outer circumference of the developing roller 21 is formed of rubber having predetermined resistance. A thickness d, of the conductive elastomer 23 is 3 mm to 6 mm.

In the conventional developing device having the above structure, the developing agent T transferred using the developing roller 21 passes between the regulating blade 26 and the developing roller 21 and forms a developing agent layer having a predetermined thickness.

In this case, the developing device 20 includes a single body cartridge with the photosensitive drum 13 and the container 27 in which the developing agent T is stored. The developing device 20 is replaced with another one when the developing agent T stored in the developing device 20 is exhausted. A waste toner storing portion 29 is provided inside the developing device 20 to store waste toner W remaining after a development operation.

In addition, the image forming apparatus prints an image on the sheet of paper S, fed using first and second paper feeding cassettes 31 and 35. The image forming apparatus has a paper feeding path 41 and a paper exhausting path 45 of the sheet of paper S. In this case, pickup rollers 32 and 36 which pick up the sheet of paper S one by one, a feed roller 33 which guides the supply of the picked-up sheet of paper S, and a registration roller 42 which feeds the fed sheet of paper S toward the photosensitive drum 13, are disposed on the paper feeding path 41. The fusing roller 19 and a plurality of paper exhausting rollers 47 are disposed on the paper exhausting path 45.

Thus, the image formed on the photosensitive drum 13 is transferred onto the sheet of paper S supplied from the first and second paper feeding cassettes 31 and 35 and fed via the paper feeding path 41, using the transfer roller 17 and is fused on the sheet of paper S using the fusing roller 19. In this way, the sheet of paper S on which a printing operation is completed, is stacked on a stacking portion 50 provided above the cabinet 10, via the paper exhausting path 45.

Meanwhile, in the developing device and the image forming apparatus having the above structure, since a thickness d₁ of the conductive elastomer 23 is 3 mm to 6 mm, a width (or an amount) of a variation in an outer diameter increases due to a variation of an ambient temperature. In other words, when the ambient temperature rises, the thickness of the conductive elastomer 23 increases, and the outer diameter of the developing roller 21 increases. On the contrary, when the ambient temperature is lowered, the outer diameter of the developing roller 21 decreases. A development nip between the developing roller 21 and the photosensitive drum 13 varies to a large width.

Thus, in an environment of a high temperature and a high humidity, due to an increase in the development nip, a pressure larger than a desired pressure is applied to the developing agent T disposed between the photosensitive drum 13 and the developing roller 21, a bending degree of a longitudinal free edge of the regulating blade 26 increases, and a nip between the supplying roller 25 and the developing roller 21 increases. As a result, stress is applied to the developing agent T, and an external additive on a surface of each developing agent is positioned inside the developing agent T or detached from the developing agent T, thereby degrading the concentration of the image and reducing a life span of the developing agent T.

### SUMMARY OF THE INVENTION

The present general inventive concept provides a developing device which prevents degrading of a concentration of an image and reducing of the life span of a developing agent by changing a structure of a conductive elastomer of a developing roller and reducing the effect caused by a variation in an ambient temperature, and an electrophotographic image forming apparatus having the same.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a developing device which develops a nonmagnetic one component developing agent in a contact development manner on a photosensitive medium on which an electrostatic latent image is formed by an incident scanned beam. The developing device may include a housing in which the developing agent is stored, and a developing agent transferring body which includes a shaft installed to be rotated inside the housing and a conductive elastomer surrounding an outer circumference of the shaft and contacting the photosensitive medium and transfers the developing agent stored in the housing to the photosensitive medium, wherein a thickness of the conductive elastomer is less than 2 mm.

The foregoing and/or other aspects and advantages of the present general inventive concept may also be achieved by providing an electrophotographic image forming apparatus which may include a cabinet, a photosensitive medium on which an electrostatic latent image is formed by an incident scanned beam, a laser scanning unit which radiates a beam so that the electrostatic latent image is formed on the photosensitive medium, a developing device which is combined with an inside of the cabinet and includes a housing storing the developing agent and a developing agent transferring body comprising a shaft installed to be rotated inside the housing and a conductive elastomer formed to a thickness less than 2 mm at an outer circumference of the shaft to transfer the developing agent stored in the housing to the photosensitive medium, and a transfer unit which transfers the image formed using the developing device onto a printing medium.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view schematically showing a structure of a conventional electrophotographic image forming apparatus;

FIG. 2 is a perspective view schematically showing a conventional developing roller of the electrophotographic image forming apparatus of FIG. 1;

FIG. 3 is a partial cross-sectional view of the conventional developing roller of FIG. 2;

FIG. 4 is a cross-sectional view schematically showing a structure of an electrophotographic image forming apparatus according to an embodiment of the present invention; and

FIG. 5 is a partial cross-sectional view of a developing roller according to the present invention.

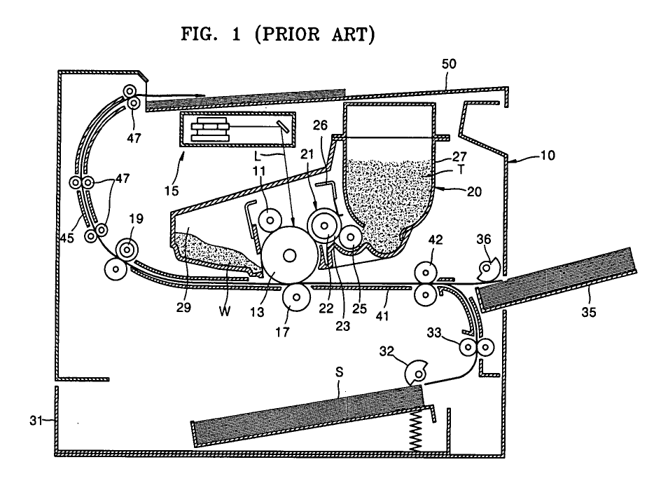

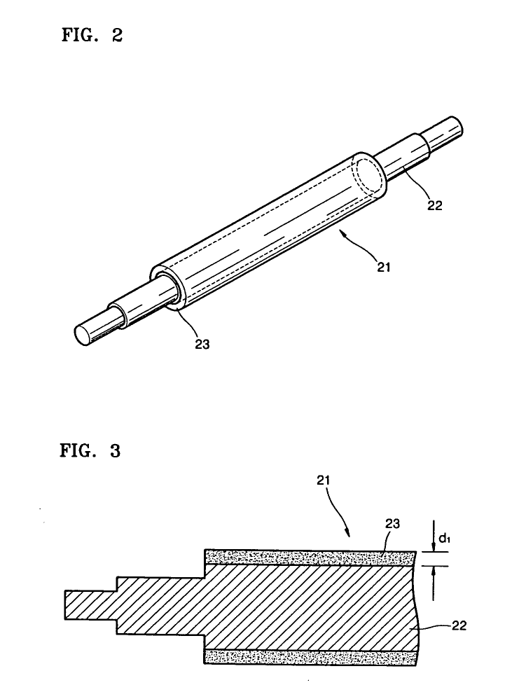

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

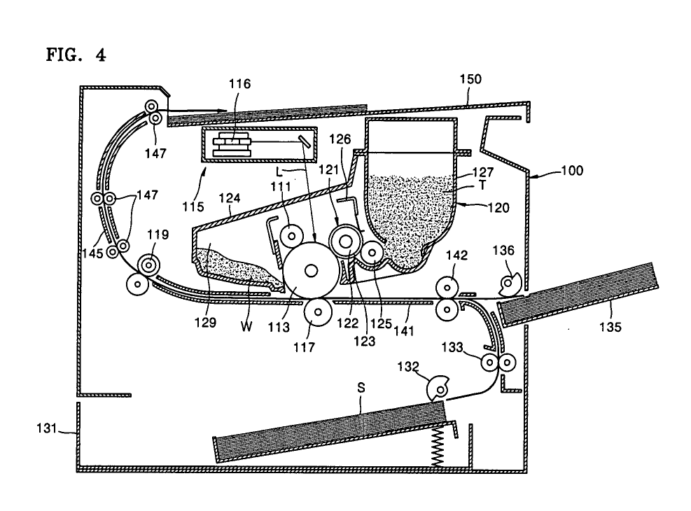

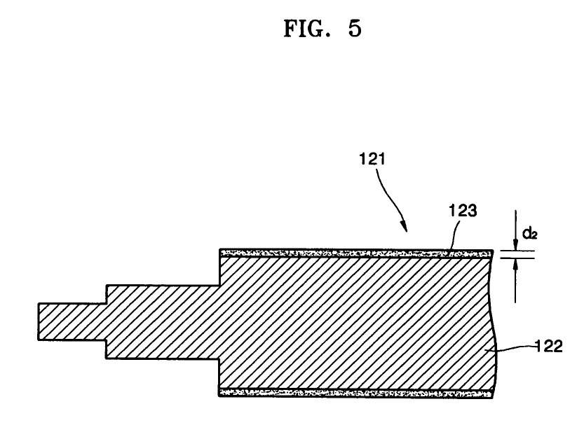

Referring to FIG. 4, an electrophotographic image forming apparatus includes a cabinet 100, a photosensitive medium 113 provided inside the cabinet 100, a laser scanning unit (LSU) 115, a developing device 120, and a transfer roller 117.

The photosensitive medium 113 is installed inside the cabinet 100, that is, inside a housing 124 of the developing device 120 to be rotated. The photosensitive medium 113 is charged to a predetermined potential using a charger 111 and forms an electrostatic latent image corresponding to an image to be printed in response to a laser beam L irradiated by the LSU 115. The photosensitive medium 113 may have a roller structure shown in FIG. 4 or a belt structure.

The LSU 115 radiates the laser beam L on the photosensitive medium 113 charged to a predetermined potential in a main scanning direction so that an electrostatic latent image corresponding to a desired image is formed. The LSU 115 includes a light source (not shown) for radiating a laser beam and a beam deflector which deflects the laser beam irradiated from the light source. In this case, a polygon mirror 116 or a hologram disc (not shown) may be used as the beam deflector. The developing device 120 develops the electrostatic latent image of the photosensitive medium 113 with a nonmagnetic one component developing agent in a contact development manner.

The developing device 120 includes the housing 124 and a developing agent transferring body (DATB) 121 provided inside the housing 124. In addition, the developing device 120 stores a developing agent T inside a container 127 and supplies the developing agent T to the photosensitive medium 113 on which the electrostatic latent image is formed, using a supplying roller 125 and the DATB 121.

Referring to FIGS. 4 and 5, the DATB 121 includes a shaft 122 installed inside the housing 124 to rotated and a conductive elastomer 123 which surrounds an outer circumference of the shaft 122 and contacts the photosensitive medium 113. In this case, a DC voltage is applied to the DATB 121. As a result, the developing agent T is supplied to the electrostatic latent image formed on the photosensitive medium 113 by electrophotography, thereby forming an image on the photosensitive medium 113. The DATB 121 is disposed to be opposite to the photosensitive medium 113 and is rotated in the same direction as the photosensitive medium 113 in a state where a predetermined development nip of about 0.2 to 4 mm is maintained.

Both ends of the shaft 122 are installed in a frame (not shown), and the shaft 122 is formed of a stainless group material having a predetermined stiffness so that bending does not occur when the shaft 122 is rotated. The conductive elastomer 123 is formed of a material having elasticity at a room temperature. The material used in forming the conductive elastomer 123 includes a mixed material of ethylene-propylene-diene-methylene (EDPM) rubber, hydrin, and conductive polymer, and a material formed of carbon black added to the mixed material. A ratio of the mixed material except for carbon black may be EDPM rubber 70%, hydrin 15%, and conductive polymer 15%.

A thickness d₂ of the conductive elastomer 123 is less than 2 mm. The thickness d₂ is smaller than the thickness of a conventional conductive elastomer so that a width variation in an outer diameter due to a variation in an ambient temperature decreases and a variation in the development nip can be minimized. Here, the thickness d₂ is a value obtained by an experimental result shown in Table 1.

Table 1 shows a comparison result in which conductive elastomers each having thicknesses of 1 mm, 2 mm, 2.5 mm, 3 mm, 4 mm, and 5 mm were formed at outer circumferences of shafts, DATB samples having an entire outer diameter of about 19.8 mm were prepared, the prepared samples were kept in a 50% RH chamber at 50° C. for 10 hours and a variation in an outer diameter of the samples was measured within one minute. Measured values were an average of values measured at 10 points of each shaft.

TABLE 1

| Thicknesses of | | | | | | |
|---|---|---|---|---|---|---|
| conductive | | | | | | |
| Elastomers | | | | | | |
| [mm] | 1 | 2 | 2.5 | 3 | 4 | 5 |
| Outer diameter | 19.800 | 19.799 | 19.791 | 19.795 | 19.799 | 19.797 |
| before meas- | | | | | | |
| urement [mm] | | | | | | |
| Outer diameter | 19.831 | 19.853 | 19.855 | 19.875 | 19.894 | 19.916 |
| after meas- | | | | | | |
| urement [mm] | | | | | | |
| Amount of | 31 | 54 | 64 | 80 | 95 | 119 |
| increase in | | | | | | |
| outer diameter | | | | | | |
| [μm] | | | | | | |

In Table 1, as the thicknesses of the conductive elastomers become larger, a variation of the outer diameter increases at a high temperature. Thus, as described above, when a thickness d₂ of the conductive elastomer is less than 2 mm, a variation in thicknesses of the conductive elastomers 123 is maintained to be less than 54 μm even when the ambient temperature rises due to a frictional heat generated by a reverse rotation between the DATB 121 and the supplying roller 125, such that a variation of the development nip can be reduced.

In this case, a regulating blade 126 is further provided at an outer circumference of the DATB 121 to regulate an amount of the developing agent T. The regulating blade 126 is fixedly formed inside the housing 124 so that an end of the regulating blade 126 contacts an outer circumference of the conductive elastomer 123. The regulating blade 126 regulates the amount of the developing agent T transferred to the photosensitive medium 113 using the DATB 121.

In addition, a waste toner storing portion 129 is provided inside the developing device 120 to store water toner W remaining after a development operation.

Meanwhile, the cabinet 100 forms a shape of the image forming apparatus, and a stacking portion 150 on which a printed medium is stacked, is provided above the cabinet 100. In addition, first and second paper feeding cassettes 131 and 135 on which a printing medium to be fed is stacked, are mounted on the cabinet 100 to be attached to or detached from the cabinet 100.

The image forming apparatus prints an image on a sheet of paper S fed by the first and second paper feeding cassettes 131 and 135 and has a paper feeding path 141 and a paper exhausting path 145 of the sheet of paper S. In this case, pickup rollers 132 and 136 which pick up the sheet of paper S one by one, a feed roller 133 which guides the supply of the picked-up sheet of paper S, and a registration roller 142 which feeds the fed sheet of paper S toward the photosensitive medium 113, are disposed on the paper feeding path 141. The fusing roller 119 and a plurality of paper exhausting rollers 147 are disposed on the paper exhausting path 145.

Thus, the image formed on the photosensitive drum 113 is transferred onto the sheet of paper S supplied from the first and second paper feeding cassettes 131 and 135 and fed via the paper feeding path 141, using the transfer roller 117 and is fused on the sheet of paper S using the fusing roller 119. In this way, the sheet of paper S on which a printing operation is complete, is stacked on the stacking portion 150 provided above the cabinet 100, via the paper exhausting path 145.

In the developing device and the image forming apparatus having the same, since the thickness of the conductive elastomer of the DATB is set to be less than 2 mm such that the width variation in the outer diameter due to a variation of the ambient temperature can be reduced. Thus, a variation of a development nip between the DATB and the photosensitive medium 113 can be minimized.

Thus, a variation in a bending degree of a longitudinal free edge of the regulating blade 126 installed to contact the conductive elastomer 123 is prevented such that stress to be applied to the developing agent T can be reduced.

In addition, the variation of the development nip is reduced such that lowering the quality of an image formed in an environment of a high temperature and a high humidity is prevented, and leakage of the image in an environment of a low temperature and a low humidity is prevented.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A developing device used with an electrophotographic image forming apparatus which develops a nonmagnetic one component developing agent in a contact development manner on a photosensitive medium on which an electrostatic latent image is formed by an incident scanned beam, the developing device comprising:
a housing in which a developing agent is stored; and
a developing agent transferring body which includes a shaft installed to be rotated inside the housing and a conductive elastomer surrounding an outer circumference of the shaft and contacting the photosensitive medium to transfer the developing agent stored in the housing to the photosensitive medium,
wherein a thickness of the conductive elastomer is less than 2 mm.

2. The developing device of claim 1, wherein the conductive elastomer is formed of a mixed material of ethylene-propylene-diene-methylene (EDPM) rubber, hydrin and conductive polymer, and carbon black added to the mixed material and has elasticity at a room temperature.

3. The developing device of claim 2, further comprising:
a regulating blade which is provided inside the housing so that an end of the regulating blade contacts the conductive elastomer, and regulates an amount of the developing agent transferred to the photosensitive medium using the developing agent transferring body.

4. The developing device of claim 1, further comprising:
a regulating blade which is provided inside the housing so that an end of the regulating blade contacts the conductive elastomer, and regulates an amount of the developing agent transferred to the photosensitive medium using the developing agent transferring body.

5. The developing device of claim 4, wherein the regulating blade comprises a free end to contact the conductive elastomer, and a variation between the free end of the regulating blade and the conductive elastomer is less than 54 μm at a room temperature.

6. The developing device of claim 1, wherein the conductive elastomer has a variation less than 54 μm in a radial direction of the shaft.

7. The developing device of claim 1, wherein the conductive elastomer is formed on the shaft by the thickness less than 2 mm in a radial direction of the shaft.

8. The developing device of claim 1, wherein the thickness of the conductive elastomer is less than 2 mm when an entire diameter of the developing agent transferring body is substantially 19.8 mm.

9. The developing device of claim 1, wherein the thickness of the conductive elastomer is less than 2 mm when a diameter of the shaft is substantially 15.8 mm.

10. An electrophotographic image forming apparatus comprising:
a cabinet;
a photosensitive medium on which an electrostatic latent image is formed by an incident scanned beam;
a laser scanning unit which radiates a beam to form the electrostatic latent image on the photosensitive medium;
a developing device which is combined with an inside of the cabinet and includes a housing to store the developing agent, and a developing agent transferring body comprising a shaft installed to be rotated inside the housing and a conductive elastomer formed to a thickness less than 2 mm at an outer circumference of the shaft to transfer the developing agent stored in the housing to the photosensitive medium to form an image; and
a transfer unit which transfers the image formed using the developing device onto a printing medium.

11. The apparatus of claim 10, wherein the conductive elastomer is formed of a mixed material of ethylene-propylene-diene-methylene (EDPM) rubber, hydrin and conductive polymer, and carbon black added to the mixed material and has elasticity at a room temperature.

12. The apparatus of claim 11, further comprising:
a regulating blade which is provided inside the housing so that an end of the regulating blade contacts the conductive elastomer, and regulates an amount of the developing agent transferred to the photosensitive medium using the developing agent transferring body.

13. The apparatus of claim 10, further comprising:
a regulating blade which is provided inside the housing so that an end of the regulating blade contacts the conductive elastomer, and regulates an amount of the developing agent transferred to the photosensitive medium using the developing agent transferring body.

14. The apparatus of claim 13, wherein the regulating blade comprises a free end to contact the conductive elastomer, and a variation between the free end of the regulating blade and the conductive elastomer is less than 54 μm at a room temperature.

15. The apparatus of claim 10, wherein the conductive elastomer has a variation less than 54 μm in a radial direction of the shaft.

16. The apparatus of claim 10, wherein the conductive elastomer is formed on the shaft by the thickness less than 2 mm in a radial direction of the shaft.

17. The apparatus of claim 10, wherein the thickness of the conductive elastomer is less than 2 mm when an entire diameter of the developing agent transferring body is substantially 19.8 mm.

18. The apparatus of claim 10, wherein the developing agent transferring body forms a development nip with the photosensitive medium, and the variation of the development nip is less than 54 μm at a room temperature.

19. The apparatus of claim 18, wherein the development nip is substantially between 0.2 and 4 mm inclusive.

20. The apparatus of claim 10, wherein the developing device comprises a supply roller to transfer the developing agent from the housing to the developing agent transferring body, and a variation between the supply roller and the conductive elastomer is substantially less than 54 μm when an entire diameter of the developing agent transferring body is substantially 19.8 mm.
